(19) United States
(12) Patent Application Publication
(10) Pub. No.: US 2023/0307744 A1
(43) Pub. Date: Sep. 28, 2023

(54) Electric Battery Assembly

(71) Applicant: Lina Energy Ltd., Lancaster (GB)

(72) Inventor: Andreas Karl Backstrom, Lancaster (GB)

(21) Appl. No.: 18/021,058

(22) PCT Filed: Aug. 13, 2021
(86) PCT No.: PCT/GB2021/052113

§ 371 Date: Feb. 13, 2023

(30) Foreign Application Priority Data
Aug. 14, 2020 (GB) 2012728.8

(51) Int. Cl. H01M 10/6563; H01M 50/224; H01M 10/657; H01M 10/658

(52) U.S. Cl. CPC H01M 10/6563; H01M 50/224; H01M 10/657; H01M 10/658

(57) ABSTRACT

An electric battery assembly (65) comprises a multiplicity of cells (10) that operate at an elevated temperature each with a metal case with a projecting flange (20), the cells being arranged in at least one stack (30). Each stack (30) locates in an aperture (36) within a generally rectangular frame (35), such that the flanges (20) of the cells (10) in the stack (30) are adjacent a wall of the frame (35). The temperature of the cells (10) can be controlled by passing a heat transfer fluid along the channels (48) defined between adjacent flanges (20) of cells (10) in the stack (30). This fluid may be air. The frame may be of insulating material, or may be of metal.

The present invention relates to an electric battery assembly that comprises a multiplicity of cells, and in particular to a battery assembly that operates at an elevated temperature.

A number of different types of electric cell are known that require an elevated temperature to operate. These include cells in which an electrolyte must be at elevated temperature to provide adequate conductivity; and cells in which an electrode must be at elevated temperature for an electrode component to be liquid. One such type of cell is a molten sodium-metal halide rechargeable battery, such as the sodium/nickel chloride cell which may be referred to as a ZEBRA cell (see for example J. L. Sudworth, “The Sodium/Nickel Chloride (ZEBRA) Battery (J. Power Sources 100 (2001) 149-163). A sodium/nickel chloride cell incorporates a liquid sodium negative electrode separated from a positive electrode by a solid electrolyte which conducts sodium ions. The solid electrolyte may for example consist of beta alumina. The positive electrode includes nickel, nickel chloride and sodium tetrachloroaluminate which is liquid during use and acts as a secondary electrolyte to allow transport of sodium ions from the nickel chloride to the solid electrolyte. The positive electrode also incorporates aluminium powder. The cell operates at a temperature which is typically below 350° C., but must be above the melting point of the sodium tetrachloroaluminate, which is 157° C., and the operating temperature is typically between 270° and 300° C. During discharge the normal reactions are as follows:

Cathode(positive electrode):NiCl₂+2Na⁺+2e⁻→Ni+2NaCl

Anode(negative electrode):Na→Na⁺+e⁻

The overall result being that anhydrous nickel chloride (in the cathode) reacts with metallic sodium (in the anode) to produce sodium chloride and nickel metal; and the cell voltage is 2.58 V at 300° C.

A modified type of a ZEBRA cell, that is to say a molten sodium-nickel chloride rechargeable cell, is described in WO 2019/073260. This uses an electrolyte element that comprises a perforated sheet of non-reactive metal, and a non-permeable layer of sodium-ion-conducting ceramic bonded to one face of the perforated sheet. In this electrolyte element the strength can therefore be provided by the metal sheet, and this enables the electrolyte thickness to be significantly reduced as compared to that required in a conventional ZEBRA cell. This results in a cell or a battery that can perform adequately at significantly lower temperatures, for example less than 200° C. Furthermore a significantly thinner layer of ceramic also significantly reduces stresses induced by heating from ambient, so start-up times from ambient can be just a few minutes. These are both commercially advantageous benefits. The non-permeable layer may be bonded to the perforated metal sheet by a porous ceramic sub-layer. Such a cell includes a metal case, which may have a peripheral flange.

According to a first aspect of the present invention there is provided an electric battery assembly that comprises a multiplicity of cells that operate at an elevated temperature, each cell having a metal case with a projecting flange, the cells being arranged in at least one stack, and the assembly comprising at least one generally rectangular frame that defines a rectangular aperture to locate at least one stack of cells, such that the flanges of the cells in each stack are adjacent a wall of the frame.

Each flange is thinner than the remainder of the metal case, so that in the stack there are gaps between the flanges of adjacent cells.

Each cell may have a metal case having opposed faces with opposite polarity, so that cells can be stacked directly in contact with each other, all with the same orientation, with all the cells of the stack being electrically in series.

The frame may be of a thermal insulation material, so it inhibits heat loss from the cells to the environment, and its strength and durability must be unaffected when in thermal contact with the cells at their operating temperature, which may be up to 300° C. or 400° C., depending on the type of cell. A suitable material may have a density less than 300 kg/m3 and a thermal conductivity less than 0.05 W/m.K. One such material is a resin-bonded sheet of rock wool fibres (made by melting rock and forming fibres from it), for example that available under the name Rockwool (trade mark), which may have a density of 100 or 140 kg/m3 and a thermal conductivity between 0.03 and 0.04 W/m.K.

The frame may alternatively be of a heat-resistant metal such as stainless steel. Such a metal frame may enclose a single stack of cells, or may enclose a plurality of stacks arranged side by side, so all the cells are in planes that are substantially parallel to each other, so that the gaps between flanges of one stack are substantially aligned with the gaps between flanges of the adjacent stack. By way of example each stack may have between 20 and 100 cells, such as 40, 45, 50, 55 or 60 cells; and a frame may enclose between 4 and 20 stacks side by side, for example 8, 10 or 12 stacks.

The electric battery assembly may also include a pump to pass a heat transfer fluid through the frame, so that the heat transfer fluid flows between the flanges of the cells adjacent to the wall of the frame. This heat transfer fluid may be air. In this case the pump may be a fan. It will be appreciated that the heat transfer fluid desirably does not undergo a phase change over the temperature range between ambient temperature and the operating temperature of the cells, so air is suitable for this purpose where the operating temperature is for example less than 400° C. During operation the cells will generate heat, so during operation the heat transfer fluid will be used to transfer heat away from the cells, to maintain the cells at an optimum operating temperature.

Where the frame encloses a plurality of stacks of cells, the frame preferably also incorporates such a pump or fan, to provide flow of the heat transfer fluid between the flanges of all the cells in all the stacks in that frame.

The assembly may also include a heater to heat the heat transfer fluid, for raising the temperature of the cells. The heater may be an electric heater.

In a second aspect, an electric battery assembly may be modular, each module comprising at least one stack of the cells located within one such rectangular frame, with the flanges of the cells in the stack adjacent to a wall of the frame. The wall of the frame may define a recess or wide groove open at one end but closed at the other end on two walls of the frame, the recess or wide groove locating edges of the cells of a stack, and the closed end of the recess preventing the stack from passing right through the frame; this is particularly appropriate where the frame is a thermally insulating frame.

Two or more such modules may be aligned with each other, the insulating frames being shaped to fit together, and may be combined with a module that incorporates a pump for a heat transfer fluid, such as a fan for air as mentioned above.

Each insulating frame may also define apertures through the walls of the frame to enable electrical contact to be made with the stack of cells. To simplify making electrical contact, each stack of cells may be provided with endplates, each endplate defining at least one electrical contact so the end plates act as electrical terminals of the stack. By way of example each endplate may define an internally threaded boss, to which a bolt can be connected, to connect to an electrical conductor such as a bus bar outside the insulating frame. Where a plurality of stacks of cells are arranged alongside each other, the stacks may be all in the same electrical orientation, and the end plates of adjacent stacks may be joined together electrically, so the cell stacks are electrically in parallel.

Where the cells define flanges on two opposed edges, the heat transfer fluid may be arranged to flow in a first direction between the flanges on one edge and the wall of the insulating frame, through each insulating frame of the assembly, and then be arranged to flow back in the opposite direction between the flanges on the opposite edge and the opposite wall of the insulating frame. This requires baffles between successive modules to separate the two flows, and an end module for the assembly which causes the heat transfer fluid to reverse its flow direction; and at the other end the pump is arranged to cause flow only between the flanges on the one edge of the stack and the adjacent wall of the insulating frame. Indeed there may optionally be two pumps, one pumping the heat transfer fluid into the assembly, to flow between the flanges on the one edge of the stack, and the other pumping the heat transfer fluid out of the assembly from between the flanges on the other edge of the stack.

Some of the benefits of the present invention are the provision of a battery assembly with reduced weight and reduced volume, and with a simplified balance of plant. The insulating frames not only inhibit heat loss from the cells, but also provide mechanical protection.

Where each frame is of metal, the assembly may again be modular, and in this case a module may consist of a frame that encloses a plurality of stacks of cells. A multiplicity of such modules may be stacked together and enclosed within a thermally insulating chamber. The thermally insulting chamber may have walls of the thermal insulation material discussed above, such as Rockwool. The chamber may enclose a multiplicity of stacks of modules, arranged alongside each other. In this case each module preferably incorporates a pump or fan to cause flow of a heat transfer fluid. Each module may also comprise at least one thermal sensor, the operation of the pump or fan being controlled in response to measurements from the sensor, to maintain a desired temperature of the stacks of cells in that module.

The thermally insulating chamber may define a first space adjacent to one end of each module, a second space adjacent to the opposite end of each module, a seal structure to inhibit flow of the heat transfer fluid outside the modules between the first space and the second space, and ports for the heat transfer fluid communicating with the first space and the second space. The ports may communicate with a heater and a recirculation duct outside the thermally insulating chamber; the recirculation duct may include three-way valves.

The invention will now be further and more particularly described, by way of example only, and with reference to the accompanying drawings in which:

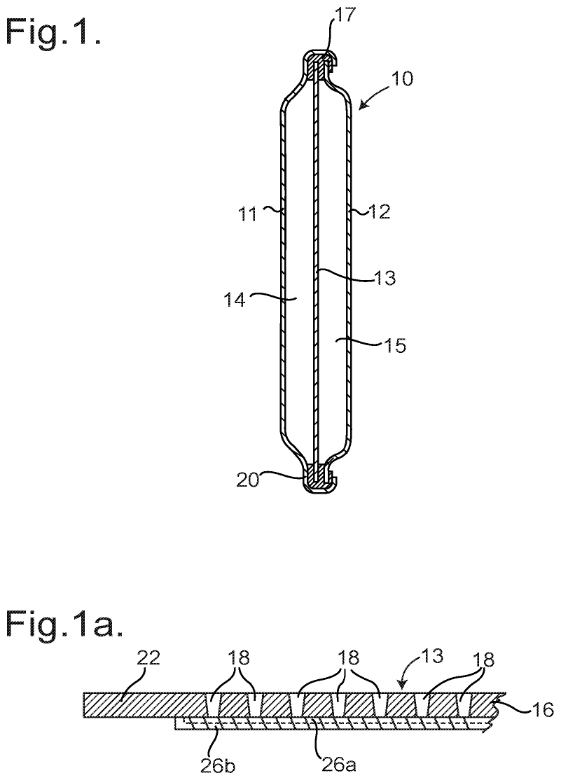

FIG. 1 shows a cross-sectional view through an electrical cell that may be used in the invention;

FIG. 1a shows a cross-sectional view of part of an electrolyte of a cell of FIG. 1;

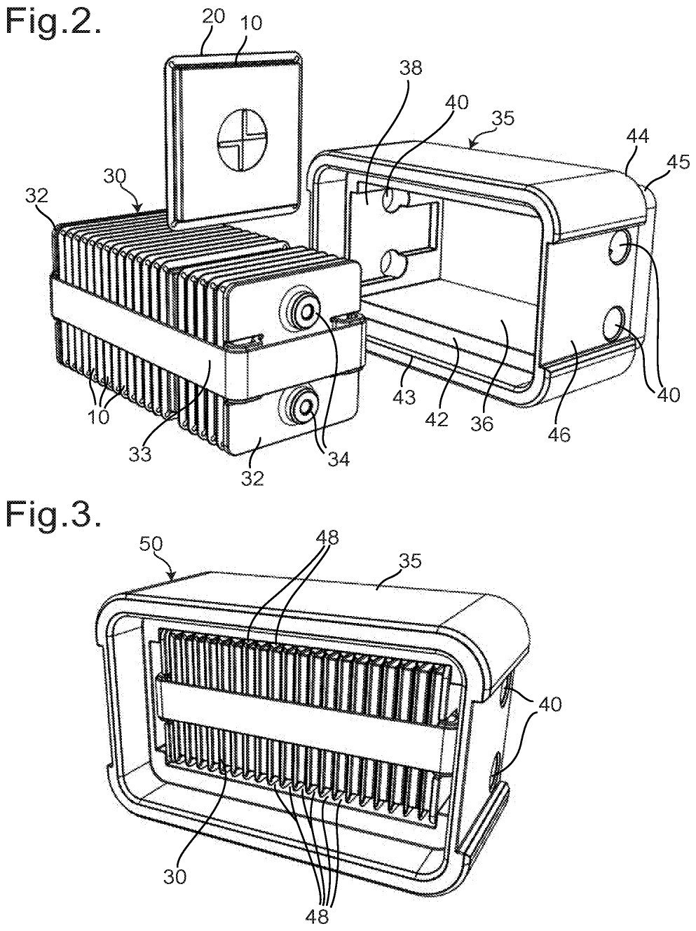

FIG. 2 shows a perspective view of a stack of cells, along with an insulating frame;

FIG. 3 shows a perspective view of the stack of cells inserted into the insulating frame of FIG. 2, which may be referred to as a battery module;

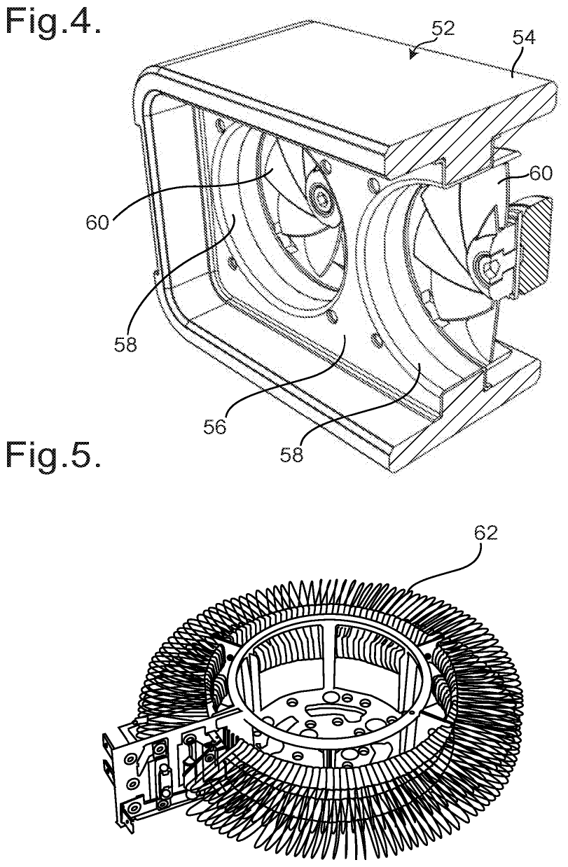

FIG. 4 shows a perspective view, partly in section, of an air fan module;

FIG. 5 shows a perspective view of an air heater;

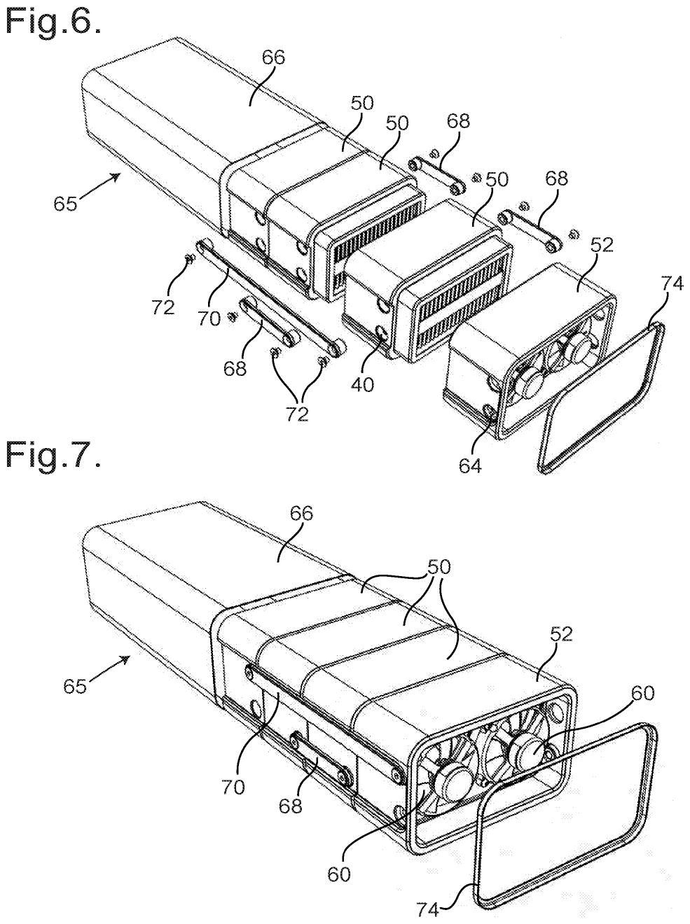

FIG. 6 shows a perspective exploded view of modules arranged for assembly into a casing;

FIG. 7 shows a perspective view at a subsequent stage of assembly;

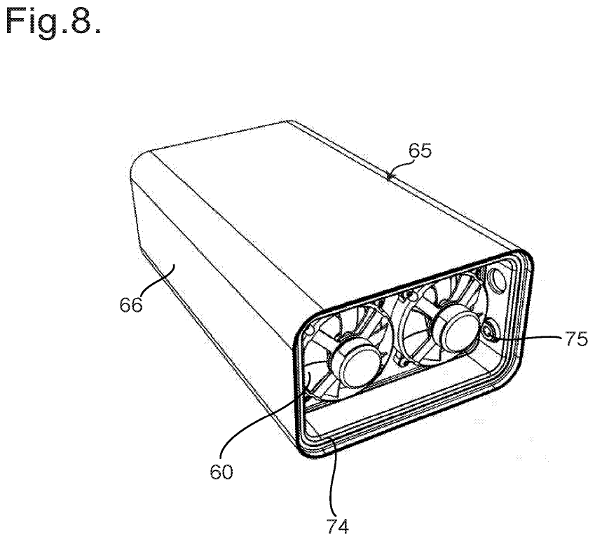

FIG. 8 shows a perspective view of the assembled electric battery assembly of the invention;

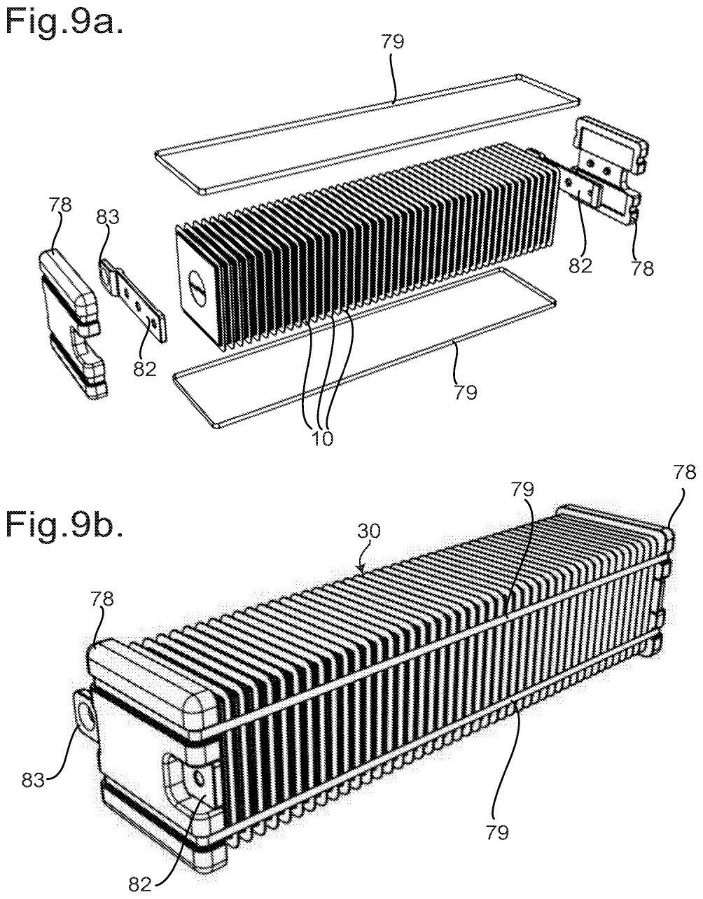

FIG. 9a shows an exploded perspective view of a stack of cells;

FIG. 9b shows a perspective view of the assembled stack of cells;

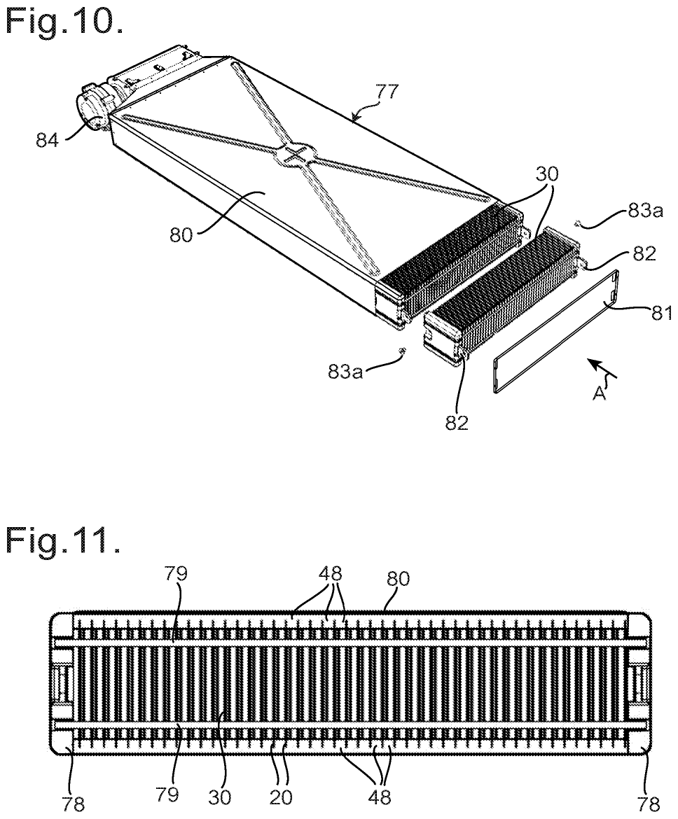

FIG. 10 shows a perspective view, partly exploded, showing stacks of cells of FIG. 9 inserted into a metal frame, to form a battery pack;

FIG. 11 shows a side view, equivalent to a view in the direction of arrow A of FIG. 10, of a stack of cells within the metal frame;

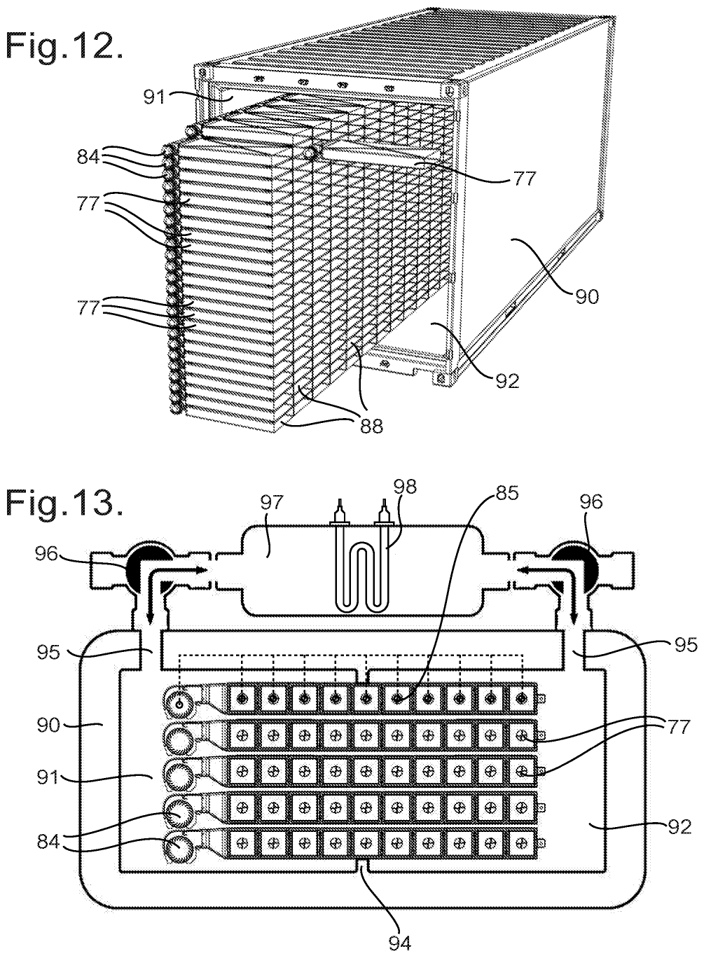

FIG. 12 shows a perspective view of a battery assembly comprising stacks of battery packs as shown in FIG. 10; and

FIG. 13 shows a schematic view of the battery assembly of FIG. 12.

Referring to FIG. 1, a cell 10 which operates at an elevated temperature comprises metal electrode plates 11 and 12, between which is a sheet of electrolyte 13. The electrode plates 11 and 12, together with the electrolyte sheet 13, define an anode space 14 on one side of the electrolyte sheet 13 and a cathode space 15 on the other side of the electrolyte sheet 13, which contain chemicals that interact as a consequence of the passage of ions through the electrolyte sheet 13 to generate electricity. Around their periphery the electrode plates 11 and 12 are sealed to the sheet of electrolyte 13 by a heat-resistant electrically-insulating sealant 17 such as PTFE, and the edges of the electrode plates 11 and 12 and of the electrolyte sheet 13 form a projecting edge flange 20 around the periphery of the cell 10, the flange 20 being thinner than the remainder of the cell 10. In this example the cell components are held together by crimping the edge of the electrode plate 11 around the edges of the electrolyte sheet 13 and the electrode plate 12, all of which are separated by the insulating sealant 17, but in some cases the sealant 17 alone may hold the components together, so no such crimping is needed. In another modification there is no insulating sealant 17 between the edge of the electrolyte sheet 13 and the edge of one of the electrode plates 11 or 12, for example the plate 11 that forms the anode space 14; these edges may be hermetically welded together, and in this case the insulated sealant 17 only separates the edge of the plate 12 from both the plate 11 and the electrolyte sheet 13. The required operating temperature clearly depends upon the nature of the chemicals and the nature of the material of the electrolyte sheet 13. For example operation may require a temperature in the range 60° C. and 300° C.

In particular the cell 10 may be a sodium/metal halide cell. One such type of cell is a sodium/nickel chloride cell. The electrode plates 11 and 12 may be of stainless steel, and of dished form to define the anode space 14 and the cathode space 15; with a flat peripheral rim. The electrolyte sheet 13 may comprise a metal sheet 16 of a metal such as nickel, or aluminium-bearing ferritic steel (such as the type known as Fecralloy (trade mark), or a steel that forms an electronically-conductive and adherent scale, for example a CrMn oxide scale, when heated in air. Most of the sheet 16 is perforated to produce a very large number of through holes 18, as shown schematically in FIG. 1a, the holes being of mean diameter 30 μm, potentially produced by a laser drilling process, or of mean diameter between 50 μm and 100 μm, and may for example be made by chemical etching. A margin 22 around the periphery of the metal sheet 16, typically of width 5 mm, is not perforated. The perforated portion of the sheet 16 is covered by a porous and permeable ceramic sub-layer 26a which is itself covered by a non-permeable ceramic layer 26b, the ceramic layer 26b being of a sodium-ion-conducting ceramic. The non-permeable ceramic layer 26b may for example comprise beta alumina, but in addition it may contain a material that forms a glass during the sintering process. Thus although it is referred to as a ceramic layer, the term “ceramic” in this context includes combinations of ceramic and glass, as long as the layer is conductive to sodium ions during operation. The non-permeable ceramic layer must not be permeable, that is to say it would be impermeable to gases, and consequently impermeable to liquids during operation. The non-permeable layer 26b also covers the edges of the sub-layer 26a.

The porous sub-layer 26a may be of the same sodium-ion-conducting ceramic as the non-permeable ceramic layer 26b, but would typically be formed from a slurry containing somewhat larger particles. The porous and permeable ceramic sub-layer 26a may be of thickness between 10 μm and 100 μm, while the non-permeable layer 26b may be of thickness in the range 5 μm to 50 μm, for example 20 μm, 30 μm or 40 μm.

In its charged state the cell 10 would contain sodium metal in the anode space 14 and nickel chloride in the cathode space 15. However, the cell would typically be assembled in a completely discharged state, with nickel powder mixed with sodium chloride in the cathode space 15. In practice the cathode space 15 would be initially filled with a powder mixture containing nickel powder, sodium chloride, and sodium aluminium chloride (sodium tetrachloroaluminate, NaAlCl₄) and preferably also a small proportion other ingredients such as iron sulphide and iron chloride, and aluminium powder, and there may also be an expanded mesh nickel sheet embedded within the powder mixture to ensure good electrical contact. The anode space 14 may initially contain carbon felt, and the surfaces of the anode space 14 may be coated with carbon black.

For the cell 10 to operate, it must first be heated to a temperature above 157° C., such as 200° C., at which the sodium aluminium chloride is molten, and at such a temperature the non-permeable ceramic layer 26b will conduct sodium ions sufficiently. The molten sodium aluminium chloride enables sodium ions to diffuse between the sodium chloride and the non-permeable ceramic layer 26b. The cell can therefore be charged by applying a voltage from an external power supply between the two electrode plates 11 and 12, so sodium ions pass through the electrolyte sheet 13 into contact with the carbon felt in the anode space 14, where sodium metal is formed, while within the cathode space 15 the remaining chloride ions react with the nickel to form nickel chloride. The cell 10 is readily reversible, so it can be charged and discharged multiple times.

Referring now to FIG. 2, twenty cells 10 (one is shown above the others) are assembled into a stack 30, all the cells 10 having the same orientation so that the cells 10 are electrically in series. At each end is an endplate 32 which defines two threaded bosses 34. The stack 30, including the endplates 32, is held together by a heat-resistant fabric strip 33. FIG. 2 also shows an insulating frame 35 of a porous ceramic material (such as a material produced by Rockwool) having a texture somewhat similar to cardboard, but being an electrical and thermal insulator, with a thermal conductivity of 0.035 W/m.K. The frame 35 is generally rectangular, with rounded external corners, and defines a rectangular duct 36 to accommodate the stack 35. Each side-wall of the rectangular duct 36 defines a wide recess 38, and two circular apertures 40, one above the other, which communicate with that recess 38; the wide recess 38 extends to one end of the frame 35, but does not extend to the other end of the frame 35, terminating just beyond the location of the apertures 40.

The wall thickness of the frame 35 is greatest in the central portion into which the stack 30 can be placed; one end of the frame 35 defines a step 42 around the inside of the walls, so defining a projecting outer wall part 43, while the other end of the frame 35 defines a step 44 around the outside of the walls, so defining a projecting inner wall part 45. The dimensions are such that if two such frames 35 are aligned and pushed together, the projecting inner wall part 45 of one frame 35 fits closely within the projecting outer wall part 43 of the other frame 35. The frame 35 also defines a shallow recess 46 on the outside of each of the side walls, each such shallow recess extending the entire length of the frame 35, and communicating with the circular apertures 40.

Referring also to FIG. 3, this shows the stack 30 located within the frame 35. The stack 30 cannot be inserted any further into the frame 35, because the threaded bosses 34 have reached the end of the recess 38. In this position the apertures 40 are aligned with the threaded bosses 34 on the endplates 32. The combination of the stack 30 within the frame may be referred to as a battery module 50. It will be appreciated that along the top and bottom surfaces of the stack 30 there are gaps 48 between the edge flanges 20 of adjacent cells 10, so in the battery module 50 there are multiple flow paths are defined by the gaps 48 and the top and bottom walls of the frame 35.

By way of example each cell 10 may be 9 mm thick and 90 mm by 90 mm in plan, so the stack 30 of twenty cells 10 and endplates 32 is of length about 0.2 m. The insulating frame may have a wall thickness of 20 mm or 30 mm.

Referring now to FIG. 4, an air fan module 52 comprises a thermally insulating rectangular frame 54, the walls of which may be of the same material as that used for the frame 35, and the external dimensions are also the same. One end of the frame 54 is of such a thickness that it can closely fit over the projecting inner wall part 45 of a battery module 50. Mounted within the centre of the rectangular frame 54 is a stainless steel frame 56 which defines two short parallel stainless steel tubular ducts 58, and at one end of each duct 58 is mounted an electrically-driven fan 60. A low-pressure rapid airflow heater element 62, as shown in FIG. 5, may be mounted within each tubular duct 58. The insulating rectangular frame 54 also defines circular apertures 64 (shown in FIG. 6) to provide access to electrical output terminals 75 (one is shown in FIG. 8) mounted within the rectangular frame 54.

Referring now to FIG. 6, an electric battery assembly 65 is shown in exploded form. The assembly 65 in this example comprises a casing 66, three battery modules 50, and the air fan module 52. In addition there are three short bus bars 68 and one long bus bar 70; eight screws 72; and a rectangular end ring 74. In this example the battery modules 50 are arranged electrically in series, so the stacks 30 in adjacent battery modules 50 are arranged in opposite orientations.

To assemble the electric battery assembly 65, the modules 50 are aligned and fitted together, with the projecting outer wall part 43 of one frame 35 fitting closely around the projecting inner wall part 45 of the adjacent frame 35, and the end wall part of the fan module 52 similarly fitting around the projecting inner wall part 45 of the adjacent frame 35. The insulating frames 35 and 54 thus form a continuous rectangular tubular duct that contains the stacks 30 and the fans 60. The bus bar 70 is then used to connect an output terminal 75 within the fan module 52 to one end of the stack 30 of the furthest battery module 50; and the bus bars 68 are used to connect the ends of successive stacks 30 together, and to connect one end of the stack 30 in the closest battery module 52 the other output terminal 75 within the fan module 52. Each connection of a bus bar 68 or 70 to a stack 30 uses a screw 72 to connect through a circular aperture 40 to the threaded boss 34 at the endplate 32 of the stack 30. It will be appreciated that the bus bars 68 and 70 locate within the shallow recesses 48. The assembly 65 is then as shown in FIG. 7.

The assembled modules 50 and 52 are then slid into the casing 66, and the end ring 74 is attached to the end of the casing 66, so securing the modules 50 and 52. The resulting electric battery assembly 65 is then as shown in FIG. 8.

In this example there is an air outlet (not shown) at the far end of the casing 66. In this situation the cells 10 of the stacks 20 can be initially heated up to operating temperature by activating both the low-pressure electrical air heaters 62 and the fans 60 so that hot air flows through the multiple flow paths defined by the gaps 48 between the edge flanges 20 of adjacent cells 10, and the top and bottom walls of the frame 35. Once the required operating temperature has achieved, which may for example be 180° C. or 210° C., the electrical heaters 62 may be switched off; and the fans 60 operated only to ensure the cells 10 do not overheat as a result of heat generated during use.

The initial heating may alternatively be achieved using hot air generated outside the assembly 65, obtained for example by combustion of a liquid fuel such as paraffin or diesel, or of a combustible gas, for example with an eberspacher external air heater (not shown), this hot air being supplied to the inlet of the fan module 52, so the fans 60 blow the hot air through the battery modules 50. Alternatively such an external heater may be a high-power electrical heater, if sufficient electrical power is available. Once the required operating temperature has been reached, this external heater would be switched off and disconnected from the inlet to the fan module 52. Subsequently the operating temperature can be maintained by passage of ambient air blown by the fans 60, if cooling is required, or passage of air heated by the electrical heaters 62 and blown by the fans 60 if heating is required.

Whether this initial heating uses the electric heaters 62 or uses an external air heater, it may be beneficial to recycle the heated air that has passed through the assembly 65 back through the heater, and then pass it through the assembly 65 again.

During use, the output terminals 75 are connected to an external electrical circuit, and the battery assembly 65 may be used to provide electric current to that external circuit. Similarly, if the cells 10 need to be recharged, this can be done by providing current via the output terminals 75 from an external charging circuit.

Throughout use, both during start-up, and during both discharging and charging of the cells 10, the fan module 52 enables the cells 10 to be kept at an optimum temperature, by heat transfer to and from the edge flanges 20. It will be appreciated that each battery module 50 may include temperature sensors (not shown) to enable the temperature of the cells 10 to be monitored.

In a modification, the fan module 52 has fans 60 arranged one above the other rather than side-by-side, arranged to create air flows in opposite directions, and includes a baffle (not shown) in each battery module 50 and the fan module 52 so that the air flow along the flow paths defined by the gaps 48 at the top of the cell stacks 30 is in the opposite direction to that along the flow paths defined by the gaps 48 at the bottom of the cell stacks 30. In this case the other end of the casing 66 would be sealed and so arranged to allow flow between the flow paths along the top of the cell stacks 30 and the flow paths along the bottom of the cell stacks 30.

As described above, the cell stacks 30 are arranged electrically in series, so that the output voltage between the output terminals 75 is the sum of all the voltages of all the cells 10. In some situations a lower voltage may be required, and the same battery modules 50 may be rearranged so that the cell stacks 30 are electrically in parallel.

In a further modification each battery assembly consists only of battery modules 50, and does not include a fan module 52. One or more such battery assemblies may be coupled to an external source of heat transfer fluid, for example an external air pump or fan, along with a heater. Hence this external source of heat transfer fluid may be used to keep each battery assembly at its optimum operating temperature.

As a further option, the battery stacks may include electrical heaters sandwiched between adjacent cells 10, and these electrical heaters are used to heat the cells 10 to the operating temperature. Once operating temperature has been achieved, flow of a heat transfer fluid such as air along the flow paths 48 between the edge flanges 20 may be used to take excess heat way from the cells 10 during use.

Referring now to FIG. 10 there is shown a battery pack 77 comprising a rectangular box-like frame 80 of stainless steel into which multiple stacks 30 of cells 10 (see FIGS. 9a and 9b) are inserted side by side, and all in the same electrical and mechanical orientation. In this example the frame 80 encloses ten cell stacks 30. At the left-hand end (as shown) of the frame 80 is a fan 84, which operates in response to signals from thermal sensors 85 (indicated schematically in FIG. 13) in the stacks 30.

Referring to FIGS. 9a and 9b, the cells 10 may be identical to the cells 10 described above. Each stack 30 of cells 10 is compressed between two electrically insulating end plates 78 by stainless steel straps 79. At each end of the stack 30 is a copper busbar 82 which is in contact with the end cell 10 of the stack 30 and locates in a groove in the face of the end plate 78; the busbar 82 has a stepped projecting end portion 83 to connect to a busbar 82 of an adjacent stack 30, and defines threaded holes for screw connectors 83a (shown in FIG. 10). The end plates 78 are wider and taller than the cells 10, so the stainless steel straps 79 are spaced away from the sides of the cells 10, and the top and bottom edges of the cells 10 are spaced away from the walls of the frame 80 (as shown in FIG. 11).

Referring again to FIG. 10, the cell stacks 30 are inserted into the frame 80, with the busbars 82 of adjacent stacks 30 being interconnected by the screw connectors 83a. After all the cell stacks 30 have been inserted, a stainless steel rectangular ring 81 is riveted into the end of the frame 80, securing the stacks 30 but leaving the end of the frame 80 open.

Referring also to FIG. 11, this shows an end view of the frame 80 with an inserted stack 30, corresponding to a view in the direction of arrow A of FIG. 10, but without the rectangular ring 81. Since the stacks 30 are side by side and in the same mechanical orientation, the gaps 48 between the edge flanges 20 of adjacent cells 10 are aligned with those in each adjacent stack 30, so there are multiple flow paths defined by the gaps 48 and the top and bottom walls of the frame 80. The fan 84 causes air to flow through all these flow paths, to emerge from the right-hand end (as shown in FIG. 10) of the frame 80. The busbars 82 of the end stack 30 extend through the rectangular ring 81 to project outside the right-hand end of the frame 80 (as shown) to act as external electrical terminals of all the cell stacks in the frame 80, and so of the battery pack 77.

As a modification, if the dimensions are such that there is a risk that the bottom edges of some of the cells 10 may come into contact with the bottom wall of the frame 80, then a thin layer of high temperature electrical insulator such as mica, may be provided on the upper surface of that bottom wall.

Referring now to FIG. 12, showing a perspective view of a battery assembly 86 while it is being assembled, multiple battery packs 77, each containing multiple stacks 30 of cells 10, may be stacked on top of each other to form a stack 88 of frames 80; and multiple stacks 88 may be arranged side by side, installed within a thermally insulating chamber 90. The chamber 90 may have walls that incorporate sheets of an insulator such as Rockwool, as described above. The stacks 88 do not occupy the entire width of the chamber 90, leaving first and second spaces 91 and 92 between the stacks 88 and the side walls of the chamber 90. There may be a framework (not shown) to support and locate the stacks 88 of battery packs 77, and there may be a seal 94 (shown in FIG. 13) between the stacks 88 and the top, bottom, front and back walls of the chamber 90 to prevent gas flow between the first and second spaces 91 and 92 around the outside of the stacks 88. The fan 84 of each battery pack 77 hence causes air flow through the frame 80 of that battery pack 77 between the first space 91 and the second space 92.

Referring to FIG. 13, the stacks 88 of battery packs 77 within the chamber 90 are shown schematically, as is the seal 94. The first and second spaces 91 and 92 are also shown. There are ports 95 communicating between the first and second spaces 91 and 92 and two 3-way valves 96. A heating chamber 97 with a heater element 98 is connected as shown between the two 3-way valves 96. As mentioned above, in each battery pack 77 the fan 84 operates in response to signals from thermal sensors 85, each stack 30 having one such sensor 85 to monitor its temperature; the sensors 85 and their connection to the fan 84 are shown schematically for one of the battery packs 77.

Prior to operation of the battery assembly 86, the cells 10 and the battery packs 77 may be at ambient temperature; the battery packs 77 must therefore heated up to their operating temperature. This may be achieved with the 3-way valves 96 in the position as shown with the ports 95 communicating with the heating chamber 97, by activating the fans 84 of each battery pack 77 and activating the heater element 98. Air heated by the heater element 98 is thereby caused to flow through each battery pack 77, and so heat up the cells in each cell stack 30 to their operating temperature. If any of the battery packs 77 are cooler than the others, the fans 84 of those battery packs 77 will draw in more hot air than the other fans 84, because the operation of each fan 84 is responsive to the temperatures of the cell stacks 30 within that battery pack 77. Hence all the battery packs 77 can be brought to the operating temperature.

During operation, the cells 10 in the battery packs 77 generate heat, and that heat must be dissipated. This is achieved by changing each 3-way valve 96 so the port 95 communicates with the surroundings rather than the heating chamber 97. In this case operation of the fans 84 draws in ambient air to the first space 91, so it flows through the battery packs 77 to the second space 92, to be discharged to the surroundings. If any of the battery packs 77 are hotter than the others, the fans 84 of those battery packs 77 will draw in more ambient air than the other fans 84, because the operation of each fan 84 is responsive to the temperature within that battery pack 77. Hence all the battery packs 77 can be maintained at a satisfactory operating temperature.

The 3-way valves 96 may be such that there may be a gradual transition between the ports 95 communicating with the surroundings and communicating with the heating chamber 97. This makes it possible to supply to the first space 91 a blend of hot recycled air and cooler ambient air, for example to achieve cooling of the battery packs 77 without generating an abrupt thermal shock.

1. An electric battery assembly that comprises a multiplicity of cells that operate at an elevated temperature, each cell having a metal case with a projecting flange, the cells being arranged in at least one stack, and the assembly comprising at least one generally rectangular frame that defines a rectangular aperture to locate at least one stack of cells, such that the flanges of the cells in each stack are adjacent a wall of the frame, each flange being thinner than the remainder of the metal case so that there are gaps between the flanges of adjacent cells wherein the assembly also includes a pump to pass a heat transfer fluid through each frame, so that the heat transfer fluid flows through the gaps between the flanges of the cells adjacent to the wall of the frame.

2. A battery assembly as claimed in claim 1 wherein each cell has a case having opposed faces with opposite polarity, so that cells can be stacked directly in contact with each other, all with the same orientation, with all the cells of the stack being electrically in series.

3. A battery assembly as claimed in claim 1 wherein the heat transfer fluid does not undergo a phase change in the temperature range between ambient temperature and the operating temperature of the cells.

4. A battery assembly as claimed in claim 1 also comprising a heater to heat the heat transfer fluid, for raising the temperature of the cells.

5. A battery assembly as claimed in claim 1 wherein the heat transfer fluid is air.

6. A battery assembly as claimed in claim 1 wherein each stack of cells is provided with endplates, each endplate incorporating at least one electrical contact.

7. A battery assembly as claimed in claim 1 wherein each frame is an insulating frame of a thermally insulating material.

8. A battery assembly as claimed in claim 7 wherein the wall of each insulating frame defines a recess or wide groove open at one end but closed at the other end on two walls of the frame, the recess or wide groove locating edges of the cells of a stack, and the closed end of the recess preventing the stack from passing right through the insulating frame.

9. A battery assembly as claimed in claim 7 which is modular, comprising a plurality of battery modules, each battery module comprising a stack of the cells located within one such rectangular insulating frame, with the flanges of the cells in the stack adjacent to a wall of the insulating frame.

10. A battery assembly as claimed in claim 9 wherein the insulating frames of adjacent battery modules are shaped to fit together, and to be combined with a module that incorporates a pump for a heat transfer fluid.

11. A battery assembly as claimed in claim 1 wherein the at least one frame is a metal frame adapted to enclose a plurality of stacks of cells, the stacks being arranged side by side.

12. A battery assembly as claimed in claim 11 wherein the at least one frame is also provided with a pump for the heat transfer fluid.

13. A battery assembly comprising a multiplicity of battery assemblies as claimed in claim 12, comprising a multiplicity of frames arranged to form a plurality of stacks of frames, wherein each frame encloses a plurality of stacks of cells, the stacks of cells being arranged side by side, and each frame is provided with a pump.

14. A battery assembly as claimed in claim 13 also comprising a thermally insulating chamber that defines a first space adjacent to one end of each frame, a second space adjacent to the opposite end of each frame, a seal structure to inhibit flow outside the frames of the heat transfer fluid between the first space and the second space, and ports for the heat transfer fluid communicating with the first space and the second space.

15. A battery system as claimed in claimed claim 12 wherein each frame also comprises a thermal sensor, and the pump associated with a frame is controlled in response to measurements from the thermal sensor associated with that frame.
